(19) United States
(12) Patent Application Publication
(10) Pub. No.: US 2004/0101454 A1
(43) Pub. Date: May 27, 2004

(54) Supported metallic catalyst and method of making same

(76) Inventors: D. Lynn Johnson, Wilmette, IL (US); Benjamin W. Ritchey, Chigago, IL (US); Vinayak P. Dravid, Glenview, IL (US); Lei Fu, Evanston, IL (US)

Correspondence Address: Mr. Edward J. Timmer, Walnut Woods Centre, 5955 W. Main Street, Kalamazoo, MI, 49009, US

(21) Appl. No.: 10/653,705

(22) Filed: Sep. 2, 2003

Related U.S. Application Data
(60) Provisional application No. 60/408,406, filed on Sep. 5, 2002.

(51) Int. Cl. B01J 23/02; B01J 8/00

(52) U.S. Cl. 422/199; 502/439; 422/198; 422/190

(57) ABSTRACT

Method and apparatus for making composite particles, such as supported metallic catalyst particles, that involve providing a vapor of a metallic catalyst material in a carrier gas flow, providing an aerosol of support particles wherein the support particles are at a lower temperature than said vapor, and contacting the aerosol and the vapor in the carrier gas flow to form particles of the metallic catalyst material on individual support particles.

This application claims the benefits of provisional application Serial No. 60/408,406 filed Sep. 5, 2002.

### CONTRACTUAL ORIGIN OF THE INVENTION

This invention was made in part using funds obtained from the U.S. Government National Science Foundation Grant No. CHE-9810378/004, and the U.S. Government may therefore have certain rights in the invention.

### FIELD OF THE INVENTION

The present invention relates to a supported metallic catalyst and to a method of making the supported metallic catalyst as well as composite particles in general.

### BACKGROUND OF THE INVENTION

Supported metallic catalysts consist of small particles of a catalytically active metal, such as but not limited to, noble metals, highly dispersed on a solid support that typically comprises an oxide, such as gamma-alumina. The properties of such catalysts have been shown to be highly dependent on both the catalyst morphology and the synthesis method employed to make the supported catalyst.

There exist some general traits common to most supported metallic catalysts. The particle size of the metallic material should be on the order of 1 to 10 nanometers (nm) to maximize the metallic surface area and thus maximize the number of active sites. The metal should be highly dispersed on the support to limit sintering of the metal during operation at elevated temperatures. The metal-support interface should be strong, again limiting sintering. The catalyst must be free of chemical impurities, such as chlorides and sulfates, that are known to cause deactivation of the catalyst.

Heretofore, the most widely employed techniques for preparing supported metal catalysts have been solution-based chemical methods. By far most common of these has been impregnation, but others such as ion-exchange, co-precipitation, deposition-precipitation, redox chemistry, and sol-gel chemistry have proven successful for preparation of active supported metal catalysts. Among the less frequently used non-solution methods, chemical vapor deposition (CVD) and derivations thereof have been commonly employed.

Both solution-based and CVD methods share many similarities that lead to some common disadvantages. The first and most important of these is that all chemical methods use a precursor material that is chemically different from the desired catalyst composition and morphology. This results in a high rate of chemical contamination that must be removed through post-synthesis treatments, which are not always completely successful. In addition to these treatments, most chemical methods involve multiple steps such as drying, calcinations, and reduction, in order to achieve the desired catalyst composition and morphology. These multiple steps are time-consuming processes that do not lend themselves well to large scale or continuous production.

Another shortcoming common to chemical synthesis routes is that they are not robust processes. That is, the chemistry and processing steps are unique to each metal-support system and not widely applicable across a spectrum of supported metallic catalysts. Similarly, because of the complex chemistry involved in the preparation of each metal-support system, little is understood scientifically as to particle formation processes, placing catalyst preparation closer to the realm of black art than science.

Physical vapor deposition (PVD) processes have been used to a limited extent for synthesizing supported metal catalysts. In their most general sense, PVD methods involve vaporization of the desired catalyst metal in a chemically inert environment and subsequent deposition of the metal on the support. In contrast to chemical methods, PVD methods are chemically pure processes with no precursors; the catalyst is synthesized in a single step process; deposition and particle nucleation and growth from the vapor phase are well-understood and well-characterized processes; and the general method of vaporization and deposition involved in PVD methods is applicable across a spectrum of supported metal catalysts.

By and large, PVD processes have heretofore been limited to synthesis of so-called model catalysts; i.e., catalysts consisting of size-selected metallic nanoparticles deposited on well-characterized thin film supports for the study of catalytic processes through surface science techniques. These studies have most often used PVD techniques borrowed from the thin film industry such as sputtering, electron beam evaporation, and laser ablation that have been modified to generate size-selected cluster beams that are then deposited on the thin film support. Other studies have also included evaporation techniques more common to the field of nanoparticle synthesis such as liquid-metal ion and arc discharge sources and supersonic expansion of a directly vaporized metal. The major drawbacks of these techniques are their very low production rate, the usual requirement of ultra-high vacuum (UHV) conditions, and the batch nature of deposition on a stationary support greatly limit their applicability to fabrication of real catalysts, rendering them largely unsuitable for scalable continuous production of supported metallic catalysts.

Sputtering and e-beam evaporation have been used in a few instances to prepare supported metal catalysts either by deposition onto a fluidized powder bed, or by co-sputtering, a technique whereby the metal and the support are simultaneously generated. While these techniques have successfully produced active supported metal catalysts, they suffer from the same problems noted above for the model catalyst synthesis techniques.

Inert gas condensation (IGC) and its various derivatives are commonly used PVD techniques for nanoparticle synthesis that are generally preferred over the vacuum techniques discussed above because of their ability to generate far greater quantities of material. To date, these techniques have been extremely limited application toward fabrication of supported metal catalysts. A possible reason for the limited success of these techniques is the inability to obtain intimate contacting between the metal nanoparticle and the support. The solution used by one worker was to co-evaporate the catalytic metal and the support in metallic form (e.g. alloy evaporation) with subsequent reaction of the support metal to create composite particles. However, this technique is limited to noble metal catalysts and metal oxide supports and offers limited control of catalyst morphology. An additional limitation of the apparatus and approach is that it is multi-step batch process that cannot easily be scaled.

### SUMMARY OF THE INVENTION

The present invention provides a PVD-based synthesis method for making composite particles and, in a particular embodiment, supported metallic catalysts as well as the particles produced by the method. A method of making composite particles involves providing a vapor of a first material in a carrier gas flow, providing an aerosol of support particles wherein the support particles are at a lower temperature than the vapor, and contacting the aerosol and the vapor in the carrier gas flow to form particles of the first material on the support particles, which may be individual particles and/or agglomerated particles.

In an illustrative method embodiment of the invention, the method of making a supported metallic catalyst comprises providing a vapor of a metallic catalyst material in a carrier gas flow, providing an aerosol of support particles wherein the support particles are at a lower temperature than the vapor, and contacting the aerosol and the vapor in the carrier gas flow to form particles of the metallic catalyst material on the support particles with the nanoparticles preferably having a major dimension of about 10 nanometers or less.

A particular method of making a supported metallic catalyst pursuant to the invention comprises flowing a carrier gas through a first chamber containing a vapor of a metallic catalyst material, discharging the carrier gas and the vapor from the first chamber trough an orifice as a gas jet into a second chamber, flowing an aerosol of support particles in the second chamber in a manner that the aerosol contacts the gas jet in the second chamber, and condensing the vapor in the gas jet as nanoparticles on the support particles.

Another embodiment of the invention provides a supported metallic catalyst comprising a plurality of the nanoparticles condensed from the vapor on each support particle. The nanoparticles can comprise a noble metal and the support particle can comprise a metal oxide or other suitable support material. Still another embodiment of the invention provides a composite particle comprising a plurality of metallic nanoparticles condensed from a vapor on individual support particles. The nanoparticles can comprise a noble metal and the support particle can comprise a metal oxide or other suitable support material.

In still another embodiment of the invention, apparatus is provided for making composite particles wherein the apparatus comprises a first chamber having means for forming a vapor of a metallic material in the first chamber, means for flowing a carrier gas in the first chamber, and an orifice through which the carrier gas and the vapor are discharged as a gas jet to a second chamber, and means for introducing an aerosol of support particles in the second chamber in a manner that the gas jet and the aerosol come into contact to deposit nanoparticles of the metallic material on the support particles.

Advantages of the present invention will become more readily apparent from the following detailed description of the invention taken with the following drawings.

### DESCRIPTION OF THE DRAWINGS

FIG. 1 is a schematic view of apparatus pursuant to an embodiment of the invention wherein the vapor of a metallic catalyst material (e.g. gold) is evaporated by a high temperature resistance heater.

FIG. 2 is a TEM of gold particles condensed on gamma-alumina support particles. The rounded grey particles are gold, while the dark or black areas are portions of the alumina support particles. The light grey mottled area is the film upon which the specimen is resting for the TEM procedure. The bar is 10 nanometers (nm) in length.

FIG. 3 is a TEM of gold particles on gamma-alumina support particles after heating at 700° C. for 18 hours. The bar is 10 nanometers (nm) in length.

FIG. 4 is a schematic view of apparatus pursuant to another embodiment of the invention wherein vapor of a metallic catalyst material is evaporated by an induction heater.

FIG. 5 is a schematic view of apparatus pursuant to still another embodiment of the invention wherein vapor of a metallic catalyst material is evaporated by an induction heater and configured for maximum stability of operation.

FIG. 6 is a schematic view of apparatus pursuant to still another embodiment of the invention wherein the apparatus of FIG. 1 is modified to minimize exposure of the aerosol to the high temperature resistance heater.

FIG. 7 is a sectional view of an aerosol generator used in the Example set forth below.

### DESCRIPTION OF THE INVENTION

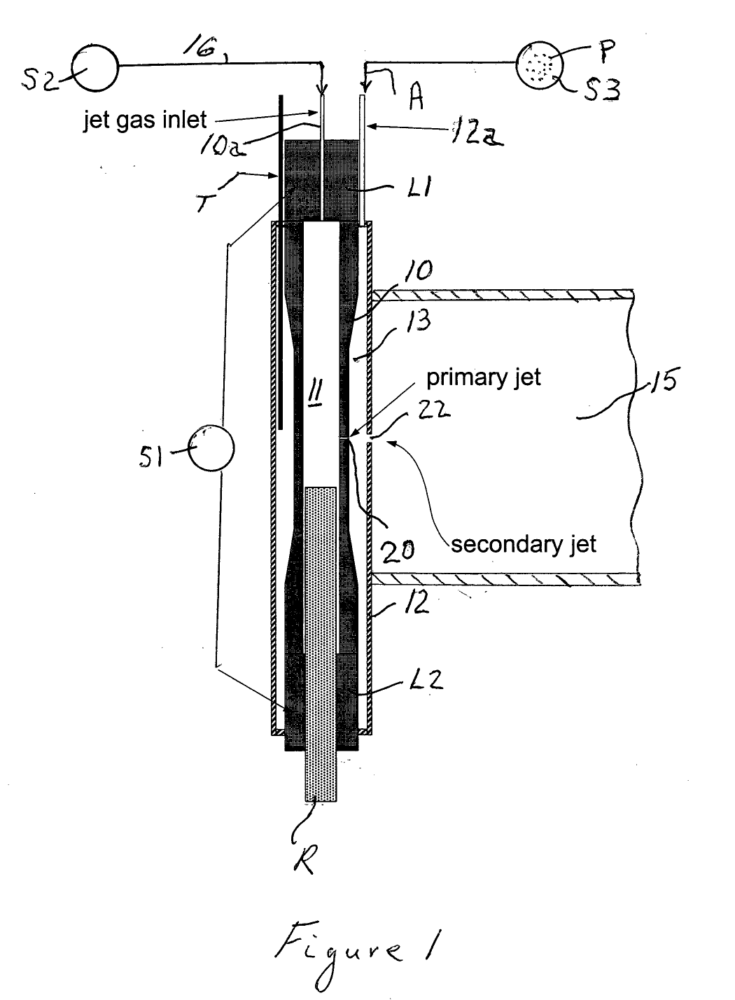

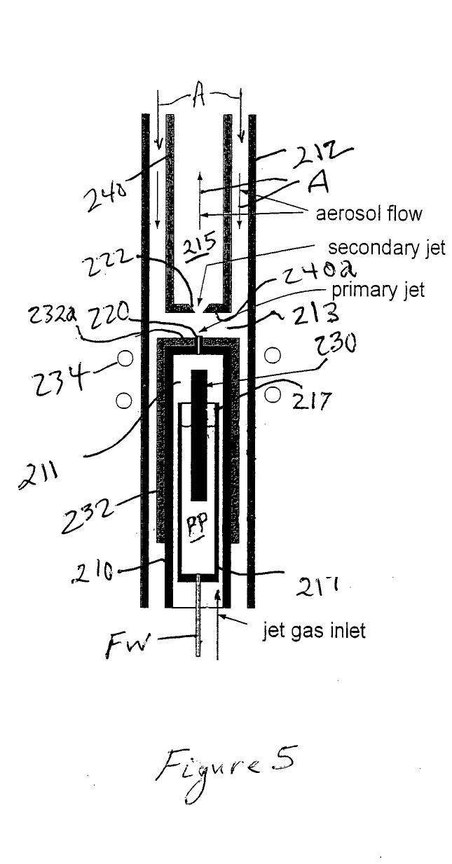

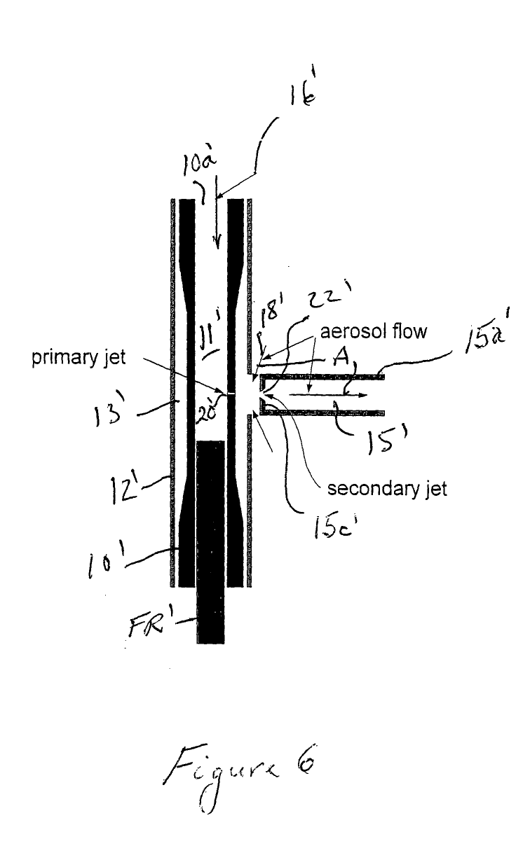

Referring to FIG. 1, apparatus pursuant to an embodiment of the invention for making composite particles is shown schematically to comprise an elongated tubular resistance heater tube 10 that forms a first evaporation chamber 11 where a vapor of a metallic catalyst material is provided. The heater tube 10 is made of graphite or other suitable material, such as a refractory metal (e.g. Mo), that can be heated by passage of an electrical current therethrough. The heater tube 10 is received within an outer tube 12 of graphite foil or other suitable refractory material that is compatible with the heater material and the aerosol of support particles at the temperatures of operation so as to form an annular second chamber 13 between the tubes 10, 12 into which an aerosol A of support particles P is introduced. The heater tube 10 and the tube 12 typically are cylindrical tubes, although any tube configuration can be used to practice the invention. A solid feed rod R comprising a metallic catalyst material is received in the lower open end of the heater tube 10. The metallic catalyst material can comprise a noble metal such as Au, Ag, Pd, Pt, Rh, or Ru and alloys thereof when composite catalyst particles are to be made. The feed rod R is advance upwardly as metallic material is melted and evaporated from the top end thereof during operation of the apparatus. Any suitable mechanical, electrical, hydraulic or other feed mechanism can be used to advance the feed rod R as needed to maintain the top end at a more or less fixed position relative to the heated central region of the heater tube 10. Dynamic control of the feed rod can be omitted in practicing other embodiments of the invention described below with respect to FIGS. 5 and 6. A thermocouple T can be provided in the second chamber 13 to monitor temperature of the central region of the heater tube 10. Evaporator apparatus of this type that can be used in practice of the invention is described in U.S. Pat. Nos. 5,618,475 and 5,665,277, the teachings of which are incorporated herein by reference. The invention envisions melting and evaporating multiple metals or alloys in the first chamber 11 as described in these patents which are incorporated herein by reference.

The invention envisions making composite particles of many types where nanoparticles of a metallic or other material are condensed on individual and/or agglomerated support particles. That is, the invention is not limited to making supported metallic catalyst particles where the metallic nanoparticles comprise a catalytic metal or alloy. Any type of metal or alloy can be melted and evaporated that provides a vapor pressure in the first chamber 11 of about 0.1 torr and above at 2500 degrees C and then condensed as nanoparticles on support particles of any kind.

The heated central region of the heater tube 10 is connected by leads L1, L2 to a source S1 of electrical power (AC or DC) to provide for flow of electrical current through the central region to electrically resistance heat the heater tube 10 and thus the metallic feed rod R received in the lower open of the heater tube 10 so as to form a molten pool of the metallic catalyst material on the top end of the feed rod R and to evaporate the molten metallic catalyst material from the pool into the first chamber 10 as described in above U.S. Pat. Nos. 5,618,475 and 5,665,277. The central region of the heater tube 10 is heated to well above the melting point of the feed rod R to this end. The vapor pressure of the evaporated metallic catalyst material in the first chamber 11 typically is maintained greater than 0.01 torr and preferably at 0.1 torr and greater. Leads L1, L2 may be connected to the ends of heater tube 10 by clamping, threading, friction fit, or any other suitable connecting means.

The heater tube 10 includes an upper end that is closed off by upper electrical lead L1 that receives a gas inlet tube 10a forming a gas inlet into the first chamber 11. The lower end of the heater tube 10 is closed off by lower electrical lead L2 and by feed rod R. The inlet tube 10a is communicated by a gas supply line 16 to an inert or reducing carrier gas source S2, such as a high pressure gas cylinder. The source S2 provides an inert or reducing gas flow to the first chamber 11 of the heater tube to carry a mixture of the vapor of the metallic catalyst material and the carrier gas to a primary discharge orifice 20 in the heater tube 10 between and separating the first chamber 11 and second chamber 13. The flow rate of carrier gas introduced into first chamber 11 is controlled by a conventional gas flow meter or mass flow controller (not shown). The mixture of the vapor of the metallic catalyst material and the carrier gas flow are discharged through orifice 20 as a high velocity gas jet into the cooler second chamber 13 where the mixture becomes supersaturated with the vapor of the metallic catalyst material. The inert gas can comprise He selected for its high heat transfer characteristics or other noble gas. The reducing gas can comprise hydrogen or other reducing gas selected in dependence on the particular metallic catalyst material being melted and evaporated from feed rod R. During operation of the apparatus, the flow rate and total system gas pressure of the inert or reducing gas is controlled as described below to control the particle size of condensed nanoparticles of the metallic catalyst material that are deposited on individual support particles of the aerosol A.

As mentioned above, the heater tube 10 is received with lateral (radial) space in the outer tube 12 so as to form an annular second chamber 13 between the tubes 10, 12 into which an aerosol A of support particles P is introduced. The aerosol A comprises a carrier gas and support particles P suspended in the carrier gas. The aerosol A is provided by a source S3 where the aerosol is formed in an inert or reducing carrier gas by a suitable aerosol generator. The aerosol generator can comprise a commercially available aerosol generator such as, but not limited to, those available from C.H. Technologies Inc., 263 Center Ave.,Westwood, N.J. 07675 or from Topas GmbH, Wilischstrasse 1, D-02179, Dresden, Germany.

The aerosol of support particles is introduced to second chamber 13 through a tube connected to aerosol inlet tube 12a. The carrier gas can comprise helium or other inert gas or hydrogen or other reducing gas, and the support particles suspended in the carrier gas can comprise metal oxide particles typically having a major dimension (e.g. diameter) in the range of 0.1 to 50 microns although the invention can be practiced using support particles of other particle major dimensions. Although it is not a requirement of the present invention, these support particles usually comprise agglomerates of much finer particles on the order of 10 to 100 nanometers in diameter. Illustrative support particles comprise alumina, titania, silica,or other metal oxide agglomerated particles having a diameter of 0.1 to 1 microns, although other individual and/or agglomerated support particles can be used in practice of the invention. Support particles having high surface areas are preferred. The flow rate of the aerosol A introduced into second chamber 13 is controlled by controlling the flow rate of the aerosol carrier gas.

The aerosol A is introduced into second chamber 13 so that a flow rate of the aerosol preferably is at least 5 times greater than the volumetric flow rate of the mixture (gas jet) through the primary discharge orifice 20 and has a temperature less than that of the vapor of the metallic catalyst material in the gas jet discharging from the orifice 20. In this way, the aerosol is swept into the gas jet discharging from the orifice 20 into the second chamber 13 and thus into the plume of vapor of metallic catalyst material to quench and condense the vapor onto the surface of individual support particles of the aerosol as discrete solid nanoparticles dispersed on the individual support particles. The aerosol typically has an inlet temperature of room temperature for quenching the gas jet discharging from orifice 20, although it is heated in the second chamber 13 by the heater tube 10 to an unknown extent in the embodiment shown in FIG. 1. The condensed nanoparticles of the metallic catalyst material typically have a major dimension, such as a diameter for spherical nanoparticles, of about 10 nm or less. The aerosol is swept with the gas jet discharging from the primary discharge orifice 20 through a radially aligned secondary discharge orifice 22 in the outer tube 12 as a secondary gas jet into a third chamber 15 enclosing the apparatus of FIG. 1 where the composite particles (i.e. support particles having condensed nanoparticles dispersed thereon) cool to ambient temperature and are collected. Quenching of the vapor of the metallic catalyst material in the gas jet discharging from orifice 20 begins in the second chamber 13 where the aerosol impinges on the gas jet from orifice 20 and continues into the third chamber 15. The diameter of primary discharge orifice 20 is less than that of the secondary discharge orifice 22.

The size of the nanoparticles condensed on the support particles is a function of the overall gas pressure of the system, typically measured in the third chamber 15, smaller nanoparticles being condensed at lower pressures. System gas pressure in the range of 20 to 100 torr is preferred, although the invention is not limited in this regard. However, the system gas pressure is maintained above a threshold pressure level below which the vapor of the metallic catalyst material condenses on surrounding surfaces of the apparatus as thin film deposits, rather than as nanoparticles on the support particles. This threshold gas pressure will vary with each particular apparatus and operating parameters and can be determined empirically if desired. The size of the nanoparticles condensed on the support particles also is a function of the flow rate of the mixture through the primary discharge orifice 20 and the flow rate through the secondary discharge orifice 22, the particle size being smaller at higher flow rates because of more rapid quenching of the gas jet discharging from orifice 20.

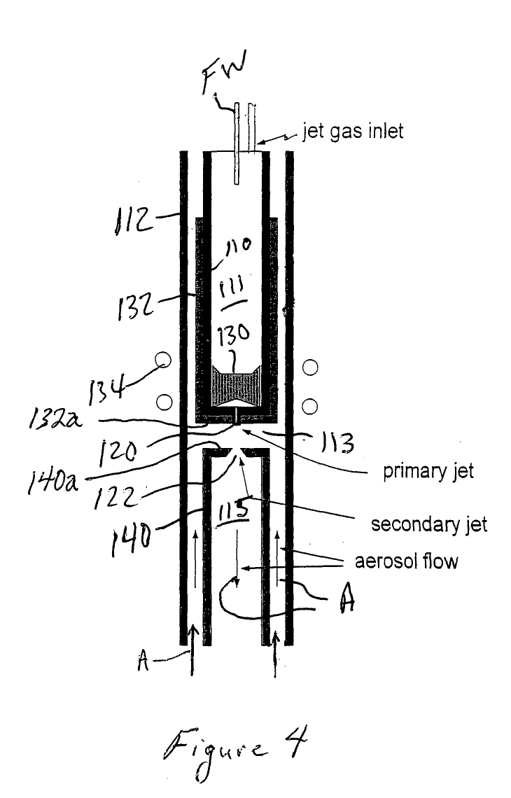

FIG. 4 illustrates apparatus pursuant to another embodiment of the invention for making the composite particles described above wherein the apparatus includes an axially elongated susceptor 110 of graphite or other suitable refractory, electrically conducting material, such as including but not limited to Mo, Ta, or W, having a first chamber 111 in which a feed wire FW is disposed axially above a porous wick 130 made of a material compatible with the vessel 110 and the liquid metal to be evaporated. An outer thermal insulation sleeve 132 is disposed about the vessel 110. The vessel 110 and wick 130 can be made of any material that couple with the field generated by the induction coil 134 disposed about the lower end of the containment vessel 110. The electromagnetic field of the induction coil 134 inductively couples with and heats the containment vessel and the wick when the induction is energized by electrical power. The feed wire FW is heated and melted as it is fed toward and approaches the hot wick 130 such that drops of molten metallic catalyst material fall onto the wick where the molten metallic catalyst material is evaporated to establish a vapor pressure of the metallic catalyst material in chamber 111. In lieu of the induction coil 134, the apparatus of FIG. 4 can be operated using a microwave heater (not shown) with proper selection of materials for the various components of the apparatus. Moreover, the wick 130 included in the embodiment of FIG. 4 and also that of FIG. 5 to be described below is not required to practice the invention and may be omitted if desired.

The vapor of the metallic catalyst material is carried by the inert or reducing carrier gas introduced into and flowing axially along the chamber 111 so as to flow through the primary discharge orifice 120 for discharge as a high velocity gas jet into a second chamber 113. The second chamber 113 is formed within outer tube 112 between the axial end wall 132a of thermal insulation sleeve 132 and facing axial end wall 140a of an elongated tube 140. Tubes 112 and 140 may be made of quartz glass, alumina, mullite, or other refractory material insulating to electric current. The elongated tube 140 defines a third chamber 115 in the quartz tube 112 and includes a secondary discharge orifice 122 axially aligned with the primary discharge orifice 120. An aerosol A of support particles in a carrier gas is flowed upwardly in FIG. 4 about the exterior of the tube 140 and then swept into the gas jet discharging from the orifice 120 into the second chamber 113 and thus into the plume of vapor of metallic catalyst material to quench and condense the vapor onto the surface of individual support particles of the aerosol as discrete solid nanoparticles dispersed on the individual support particles in the manner described above. The aerosol A is swept with the gas jet discharging from the primary discharge orifice 120 through secondary discharge orifice 122 as a secondary gas jet into the third chamber 115 from which the composite particles (i.e. support particles having condensed nanoparticles dispersed thereon) are conducted to a collection chamber (not shown) to cool to ambient temperature and be collected. Quenching of the vapor of the metallic catalyst material in the gas jet discharging from orifice 120 begins in the second chamber 113 where the aerosol impinges on the gas jet from orifice 120 and continues into the third chamber 115. Active control of both the feed rate of feed wire FW and the evaporation rate from the wick (via control of the temperature of the containment vessel and the wick) achieve production of the desired composite particles.

FIG. 5 illustrates apparatus that can achieve stable operation without dynamic control of feed rate of feed wire FW and the evaporation from the wick. In particular, the apparatus includes an axially elongated susceptor containment vessel 210 having a first chamber 211 in which a feed wire FW is disposed axially below a porous wick 230. An outer thermal insulation sleeve 232 is disposed about the vessel 210. The vessel 210 and wick 230 can be of other material that couple with the field generated by the induction coil 234 disposed about the upper end of the containment vessel 210. The field of the induction coil 234 inductively couples with and heats the containment vessel and the wick when the induction is energized by electrical power. The feed wire FW comprising the metallic catalyst material is fed into the crucible 217 through its bottom and is heated and melted as it is fed upwardly to form a pool PP of molten metallic catalyst material in the crucible. The hot wick 230 extends downwardly into the molten pool P of the metallic catalyst material in the crucible such that the molten metallic catalyst material is wicked upwardly where the molten metallic catalyst material is evaporated to establish a vapor pressure of the metallic catalyst material in chamber 211. The system of FIG. 5 is inherently stable due to the temperature gradient along the axis of the chamber 210 and due to the molten metallic catalyst material seeking a level on the wick such that evaporation rate is equal to the feed rate of feed wire, provided the feed rate is not greater than the greatest possible evaporation rate. In lieu of the induction coil 234, the apparatus of FIG. 5 can be operated using a microwave heater (not shown) with proper selection of materials for the various components of the apparatus.

The vapor of the metallic catalyst material is carried by the inert or reducing carrier gas introduced into and flowing axially along the chamber 211 so as to flow through the primary discharge orifice 220 for discharge as a high velocity gas jet into a second chamber 213. The second chamber 213 is formed within tube 212 between the axial end wall 232a of sleeve 232 and facing axial end wall 240a of an elongated tube 240. Tubes 212 and 240 can be made of quartz glass, alumina, mullite, or other suitable material insulating to electrical current. The elongated tube 240 defines a third chamber 215 and includes a secondary discharge orifice 222 axially aligned with the primary discharge orifice 220. An aerosol A of support particles in a carrier gas is flowed downwardly in FIG. 5 about the exterior of the tube 240 and then swept into the gas jet discharging from the orifice 220 into the second chamber 213 and thus into the plume of vapor of metallic catalyst material to quench and condense the vapor onto the surface of individual support particles of the aerosol as discrete solid nanoparticles dispersed on the individual support particles in the manner described above. The aerosol A is swept with the gas jet discharging from the primary discharge orifice 220 through secondary discharge orifice 222 as a secondary gas jet into the third chamber 215 from which the composite particles (i.e. support particles having condensed nanoparticles dispersed thereon) are conducted to a collection chamber (not shown) to cool to ambient temperature and be collected. Quenching of the vapor of the metallic catalyst material in the gas jet discharging from orifice 220 begins in the second chamber 213 where the aerosol impinges on the gas jet from orifice 220 and continues into the third chamber 215.

Referring to FIG. 6, a modification of the apparatus of FIG. 1 is illustrated where like features of FIG. 1 are represented by like reference numerals primed. FIG. 6 differs from FIG. 1 in having a third chamber 15′ in the form of an elongated snorkel tube 15a′ having a secondary discharge orifice 22′ in an end wall 15c′ radially aligned with orifice 20′ so that the secondary gas jet is formed in and flows along the third chamber 15′. FIG. 6 also differs in having an aerosol inlet 18′ located at the juncture of the second and third chambers 13′,15′ so as to reduce the time of exposure of the aerosol to the high temperature heater tube 10′. In FIGS. 4, 5, and 6, the first and second chambers are closed off by suitable tube end caps (not shown) with appropriate inlets for the carrier gas, aerosol, and feed wire or rod.

### EXAMPLE

### Example 1

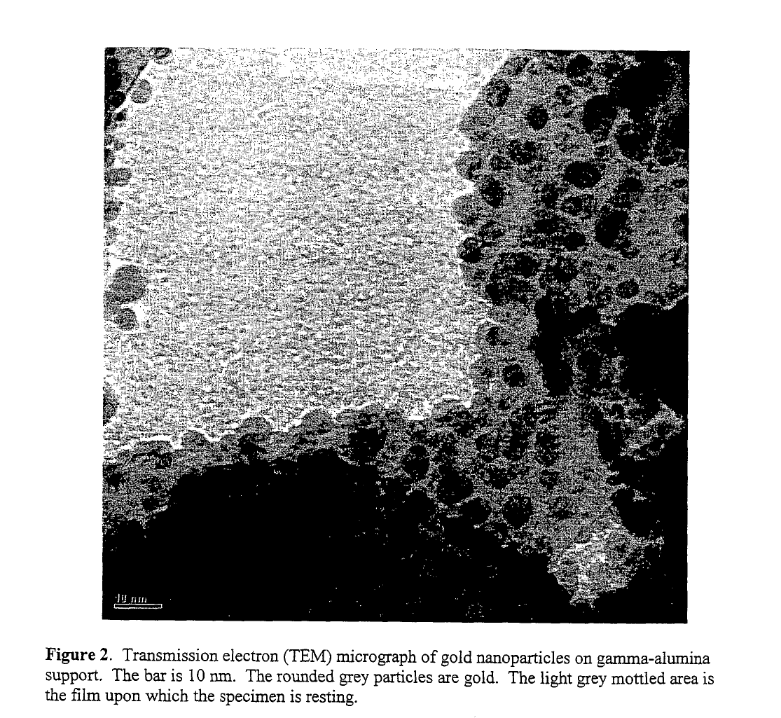

Referring to FIG. 2, a supported metallic catalyst pursuant to the invention is shown. In particular, FIG. 2 is a transmission electron micrograph (TEM) of gold nanoparticles having a diameter of less than 10 nm (e.g. average nanoparticle diameter of about 8 nm) condensed and dispersed on high surface area gamma phase-alumina support particles is provided. The rounded grey particles are gold, while the dark or black areas are portions of the alumina support particles. The light grey mottled area is the film upon which the specimen is resting for the TEM procedure. For reference purposes, the dimensional bar is 10 nm in length.

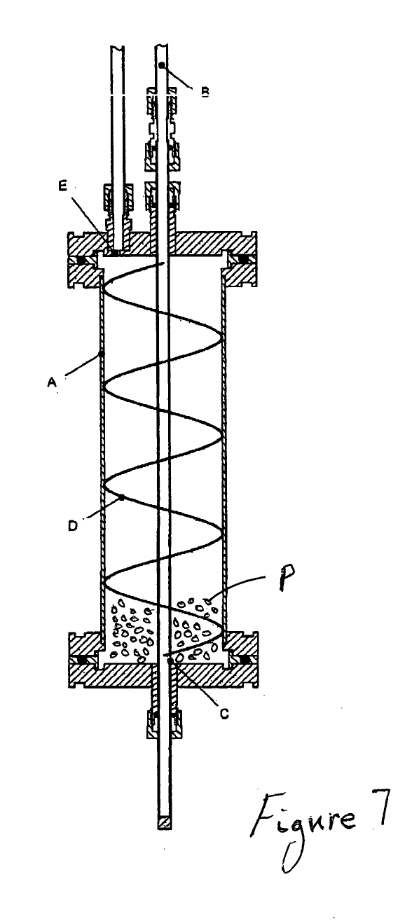

The specimen supported metallic catalyst of FIG. 2 was made using apparatus similar to that of FIG. 1 with the exception that the gold was contained in a crucible held at a position corresponding to the top end of the feed rod R shown in FIG. 1. The crucible comprised alumina material. The heater tube 10 was made of graphite with an inner diameter of 0.5 inch, an outer diameter of 0.625 inch, and a length of the reduced-diameter region was 4 inches. The tube 12 was formed from graphite foil with a diameter of 1.2 inches. An alternating electric current of about 350 amperes passing through the heater tube was sufficient to raise its temperature to 1800° C. The diameters of the primary and secondary discharge orifices 20, 22 were 0.039 inch and 0.18 inch, respectively. The temperature of the heater tube 10 for the specimen shown was 1760° C., at which the vapor pressure of gold is approximately 0.35 torr. The aerosol comprised gamma-alumina particles having an average agglomerate diameter of 0.3 micrometers suspended in helium carrier gas initially at room temperature. The aerosol was generated using the aerosol generator shown in FIG. 7 where the support particles P were disposed in reservoir A and stirred by rotating stirrer wire D while the carrier gas was percolated up from a gas inlet hole C having a 1 millimeter diameter. Gas inlet tube B supplied the carrier gas to the hole C. The aerosol was discharged through a 1 millimeter aerosol exit E to flow to the aerosol inlet 12a of FIG. 1.

The volumetric flow rates of the primary carrier gas (He gas) in chamber 11 and the aerosol in chamber 13 were 34.1 cc/min and 511 cc/min (at standard temperature and pressure), respectively. The total system pressure was 50 torr. Thus, the average linear flow rate in the primary discharge orifice 20 was about 75 m/s (meters/second), and the average linear flow rate in the secondary discharge orifice 22 was about 50 m/s, assuming the perfect gas law and taking into account the fact that the temperature of the gas jet at the secondary discharge orifice 22 will be lower than at the primary discharge orifice 20.

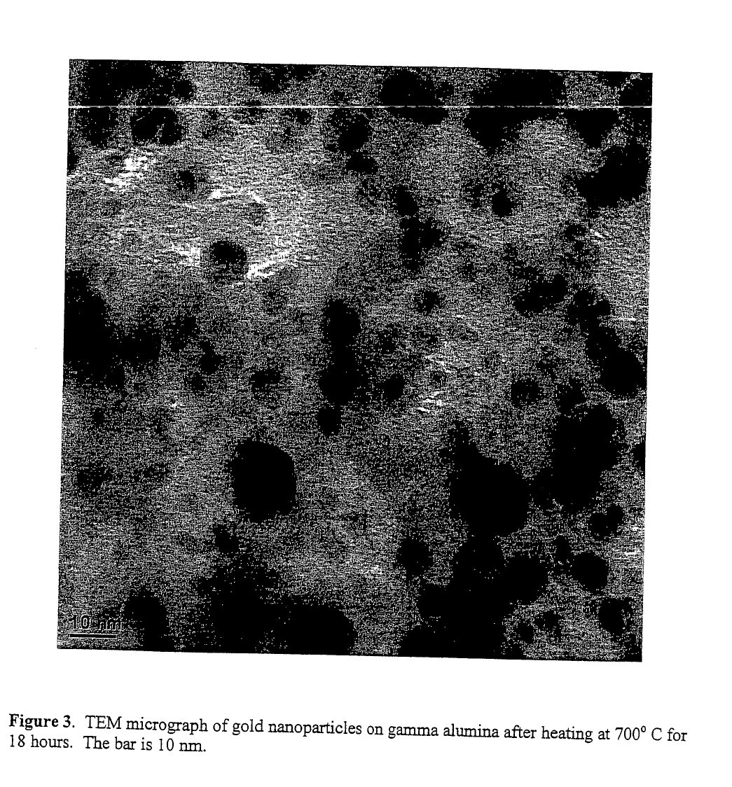

The gold nanoparticles are strongly adhered to the gamma-alumna micrometer-sized support particles and were stable against sintering during elevated temperature exposure at 700° C. for 18 hours in air. FIG. 3 is a TEM of the gold nanoparticles on gamma-alumina support particles after such heating at 700° C. for 18 hours. The reference bar is 10 nm in length.

Gold nanoparticles having smaller particle diameters (e.g. average 3 nm diameter) have been produced on similar support particles in other tests using similar parameters as the Example for making supported metal catalysts wherein the heater tube temperature was 1750° C. and total system pressure was 50 torr. The evaporation rate of gold was 1-2 g/hr with a primary gas (He) flow rate of 33.4 cc/min (STP-standard temperature and pressure). The aerosol flow rate was 15-30 g/hr of alumina particles with a secondary gas (He) flow rate of 500 cc/min (STP).

Although the invention has been described above with respect to certain embodiments, those skilled in the art will appreciate that the invention is not limited to these embodiments since modifications, changes, and the like can be made therein without departing form the spirit and scope of the invention as set forth in the appended claims.

We claim:

1. A method of making composite particles, comprising, providing a vapor of a first material in a carrier gas flow, providing an aerosol of support particles wherein the support particles are at a lower temperature than the vapor, and contacting the aerosol and the vapor in the carrier gas flow to form particles of the first material on the support particles.

2. The method of claim 1 wherein the first material is metallic, and the support particles comprises a different material.

3. The method of claim 2 wherein the different material is non-metallic.

4. The method of claim 1 wherein the vapor condenses as nanoparticles on the support particles, the nanoparticles having a major dimension of about 10 nanometers or less.

5. The method of claim 1 wherein the support particles include at least one of individual particles and agglomerated particles.

6. A method of making a supported metallic catalyst, comprising, providing a vapor of a metallic catalyst material in a carrier gas flow, providing an aerosol of support particles wherein the support particles are at a lower temperature than the vapor, and contacting the aerosol and the vapor in the carrier gas flow to form particles of the metallic catalyst material on the support particles.

7. The method of claim 6 wherein the vapor condenses as nanoparticles on the individual support particles, the nanoparticles having a major dimension of about 10 nanometers or less.

8. The method of claim 6 including evaporating the metallic catalyst material in a first chamber to form the vapor, and introducing the carrier gas flow into the first chamber to carry the vapor into a second chamber where the aerosol is introduced.

9. The method of claim 8 including flowing the aerosol and the vapor in the carrier gas through a second orifice into a third chamber.

10. The method of claim 6 wherein the vapor has a vapor pressure of 0.01 torr and above in the first chamber.

11. The method of claim 10 wherein the vapor pressure is 0.1 torr and above.

12. The method of claim 6 wherein the carrier gas flow comprises an inert gas or reducing gas.

13. The method of claim 6 wherein the aerosol includes support particles having an individual or agglomerated particle diameter in the range of 0.1 to 50 micrometers.

14. The method of claim 6 wherein the support particles comprise a metal oxide.

15. The method of claim 14 wherein the metal oxide is selected from the group consisting of alumina, titania, and silica.

16. The method of claim 6 wherein the metallic catalyst material comprises a noble metal selected from the group consisting of Au, Ag, Pd, Pt, Rh, and Ru.

17. The method of claim 8 including disposing the first chamber within the second chamber with the orifice extending through a wall between the first chamber and the second chamber and with the orifice communicating with a third chamber via a secondary orifice.

18. The method of claim 8 including disposing the first chamber with an end wall having the orifice therein communicating with the second chamber and communicating with a secondary orifice in a facing end wall of a third chamber.

19. A method of making a supported metallic catalyst, comprising, flowing a carrier gas through a first chamber containing a vapor of a metallic catalyst material, discharging the carrier gas and the vapor from the first chamber through an orifice as a gas jet into a second chamber, flowing an aerosol of support particles in the second chamber in a manner that the aerosol contacts the gas jet in the second chamber, and condensing the vapor in the gas jet as nanoparticles on the support particles.

20. Composite particles, comprising a plurality of nanoparticles condensed on one or more support particles, the nanoparticles comprising a material different from that of the support particles and having a major dimension of about 10 nanometers or less.

21. Supported metallic catalyst, comprising a plurality of nanoparticles condensed on one or more support particles, the nanoparticles comprising a catalytic metallic material and having a major dimension of about 10 nanometers or less.

22. The catalyst of claim 21 wherein individual or agglomerated support particles each has a major dimension in the range of 0.1 to 50 micrometers.

23. The catalyst of claim 21 wherein the nanoparticles comprise a noble metal and the support particle comprises a metal oxide.

24. The catalyst of claim 21 comprising noble metal nanoparticles condensed on an alumina support particle.

25. Apparatus for making composite particles, comprising a first chamber having means for forming a vapor of a first material in said first chamber, means for flowing a carrier gas in said first chamber, and an orifice through which the carrier gas and the vapor are discharged as a gas jet to a second chamber, and means for introducing an aerosol of support particles in the second chamber in a manner that the gas jet and the aerosol come into contact to deposit nanoparticles of the first material on individual support particles.

26. The apparatus of claim 25 wherein the first chamber is disposed within the second chamber and the orifice extends through a wall between the first chamber and the second chamber.

27. The apparatus of claim 26 further comprising a third chamber communicating with the second chamber via a secondary orifice which is laterally aligned with said orifice.

28. The apparatus of claim 27 wherein an aerosol inlet is disposed at a junction between the second chamber and the third chamber.

29. The apparatus of claim 25 wherein the first chamber includes an end wall having the orifice therein communicating with the second chamber, the second chamber communicating with a third chamber via a secondary orifice disposed in an end wall of the third chamber and axially aligned with said orifice.

30. The apparatus of claim 25 including a crucible for containing molten metallic material in the first chamber and from which crucible the vapor is evaporated.

31. The apparatus of claim 25 including a wick from which molten metallic material is evaporated.
